(19) United States
(12) Patent Application Publication
(10) Pub. No.: US 2005/0281195 A1
(43) Pub. Date: Dec. 22, 2005

(54) Secure content management method and system

(76) Inventors: Kan Zhang, Palo Alto, CA (US); Andrew Fitzhugh, Menlo Park, CA (US); Robert Tarjan, Princeton, NJ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/872,110

(22) Filed: Jun. 17, 2004

(51) Int. Cl. H04L 12/26

(52) U.S. Cl. 370/235; 370/229

(57) ABSTRACT

A method of controlling transmission of content in a network. The method includes the step of applying a quality degradation procedure to content being transmitted between nodes of the network.

### FIELD OF THE PRESENT INVENTION

The present invention relates broadly to a method of controlling transmission of content in a network, and more specifically to a quality manipulation system for controlling transmission of content in a network.

### BACKGROUND OF THE PRESENT INVENTION

The popularity of file sharing on peer-to-peer networks, such as Napstar, Kazaa and Morpheus, has created significant copyright, security and privacy infringement concerns for both commercial media providers and private users. A peer-to-peer network may be seen as a network of Peer nodes interconnected by a network that possibly includes one or more intermediate nodes.

Intermediate nodes can include, but are not limited to network components such as routers and servers and other network hardware devices that communicate network traffic over the network.

The “owner” of a node can set an access control policy on his or her own node, but has no authority on other users' nodes. The local access control policy would typically specify access control conditions for the digital media originating from/stored on the node. However, once digital media has been accessed/retrieved from the node in compliance with the local control policy, the further fate of the accessed content is typically beyond the control of the owner of the node.

Implementation of centralized security policies has been utilized to address secure content management issues. In such implementations, dedicated modules are provided at the nodes to consult with a security policy engine typically operated on a server on the network, requiring hand-shake communications between the nodes and the server for each attempted access to stored content on the nodes of the network.

Accordingly there is a need to provide a method for controlling the transmission of digital content between the nodes of a network that addresses the security and/or privacy concerns described above.

### SUMMARY OF THE PRESENT INVENTION

Briefly a method of controlling transmission of content in a computer network is disclosed. The method includes applying a quality degradation procedure to content being transmitted between nodes of the network. dr

### BRIEF DESCRIPTION OF THE DRAWINGS

Embodiments of the invention will now be described by way of non limiting example, with reference to the accompanying drawings, in which:

FIG. 1 is a flowchart illustrating a method of controlling transmission of content between two nodes of a network, in accordance with an embodiment of the present invention;

FIG. 2A is a schematic drawing illustrating a peer-to-peer network in accordance with an embodiment of the present invention;

FIG. 2B is a schematic drawing showing a detail of FIG. 2A in accordance with an embodiment of the present invention; and

FIG. 3 is a flowchart illustrating another method of controlling transmission of content between two nodes of a network, in accordance with an embodiment of the present invention.

### DETAILED DESCRIPTION OF THE EMBODIMENTS

An embodiment of the present invention will now be described, by way of example only, in the context of a peer-to-peer network. However the present invention should not be construed as being limited to application in peer-to-peer networks only, but should be considered applicable to computer networks generally.

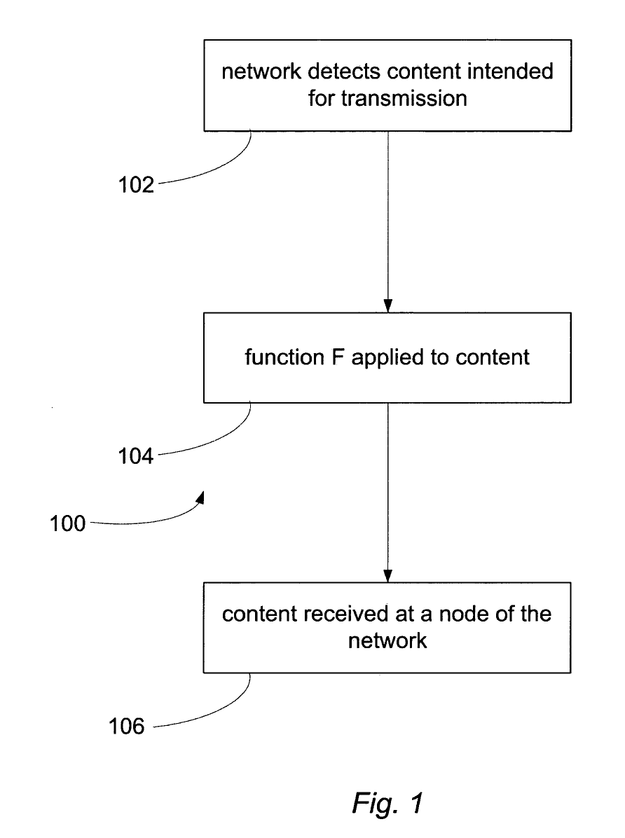

FIG. 1 shows a flowchart 100 of a method of controlling transmission of content in a peer-to-peer network in accordance with an embodiment of the present invention. In step 102, a network detects content intended for transmission. In step 104, a function F is applied to the content. In an embodiment the function F is a quality degradation function. The content degraded by the application of the function F is then received at a receiving node via step 106.

By choosing a suitable function F to apply to the content, the quality of the content as received in stop 106 is only affected slightly, such that the intended purpose of the content is substantially maintained.

If the same content is intended for further transmission from the receiving node, the network again detects that intention at step 102 of the flowchart 100 in FIG. 1. The network then applies the function F to the content at step 104, i.e. the function F is applied to the content for a second time, prior to reception (in step 106) of the content of a subsequent receiving node.

The function F in the example embodiment is chosen such that when applied twice to transmitted content, the quality of the content is significantly degraded. It will be appreciated by a person skilled in the art that the degree or nature of the degradation may take a variety of different forms. For example, it could be that the content is no longer useful for all possible purposes. Alternatively, the content may only be degraded for a specific purpose, e.g. an image may still be recognizable on-screen, but degraded when printed.

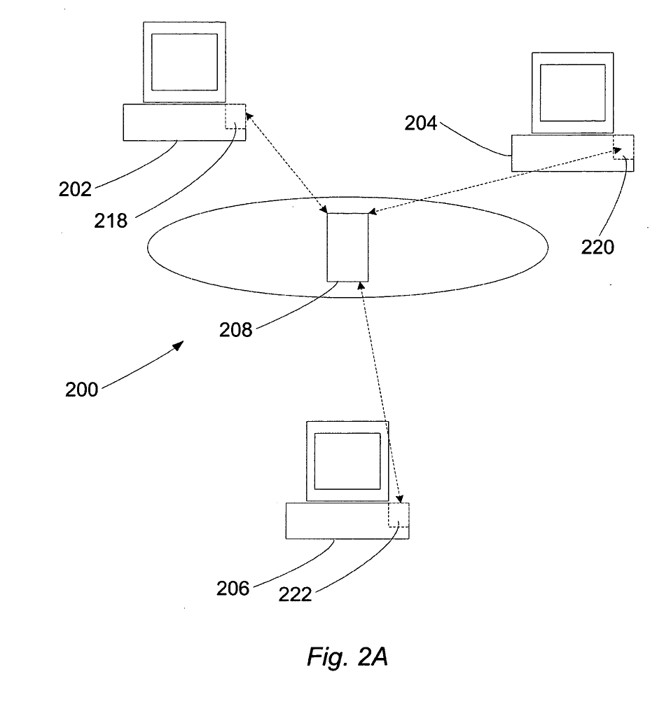

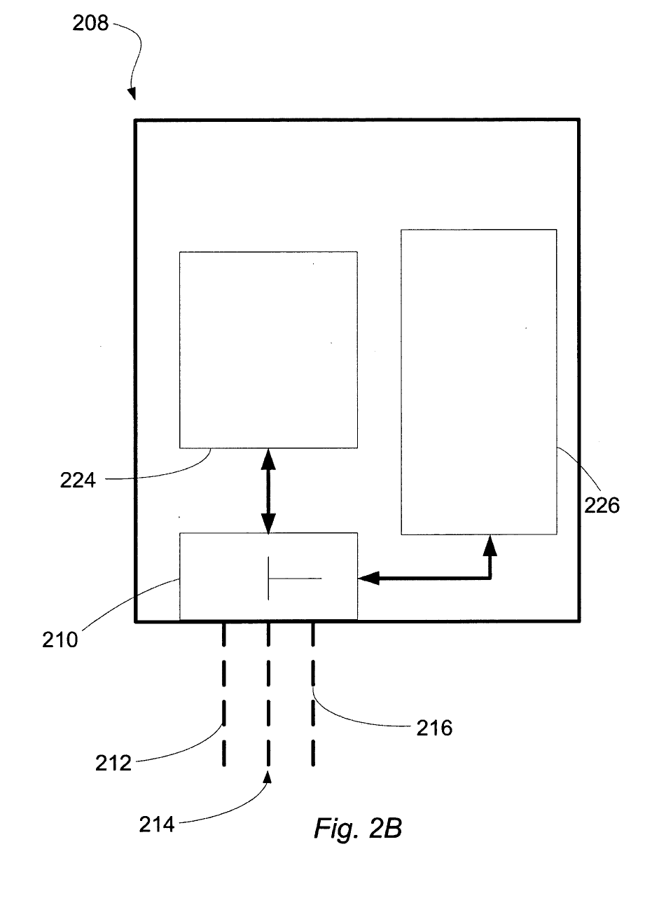

FIG. 2 shows an example of a peer-to-peer network 200 that could be utilized in conjunction with an embodiment of the present invention. The network 200 includes a number of peer nodes in the form of individual PCs 202, 204 and 206. An intermediate node in the form of a router 208 facilitates interconnectivity of the peer nodes 202, 204, and 206. The router 208 of the example embodiment is shown in more detail in FIG. 2B. The router 208 includes an interface element 210 to the communication paths indicated at numerals 212, 214 and 216 to transmission units in the form of network cards 218, 220 and 222 of PCs 202, 204, and 206 respectively (see FIG. 2A).

The router 208 further includes an application element 224 for applying a quality degradation procedure to content being transmitted between the terminal nodes of the network. In operation, content received at the interface element 210 to be transmitted between terminal nodes of the network, is provided to the application element 224. In the application element 224 the content is subjected to a processing step, in the example embodiment random noise is added to the content.

The content is then returned to the interface element 210 and directed to a routing element 226 of the router 208 for routing the content to the appropriate receiving node via one or more of the communication paths 212, 214, and 216.

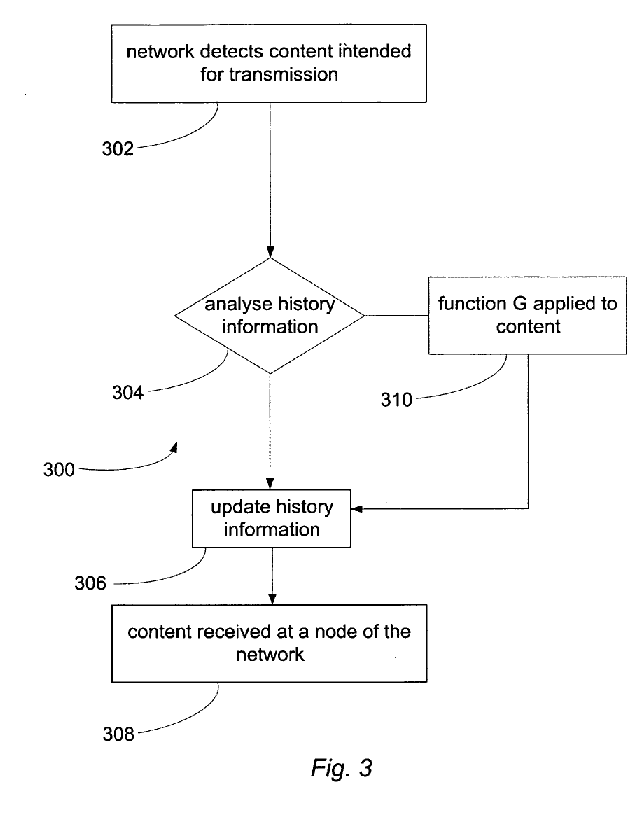

An alternative method of controlling transmission of content in a computer network is illustrated in flowchart 300 in FIG. 3. The network detects that content is intended for transmission between peer nodes of the network at step 302. History information associated with the content is analyzed at step 304. If the history information indicates that the content is being transmitted for the first time, the history information is updated at step 306 to indicate that the content has now been sent for the first time. The content is then received at a node of the network at step 308, without any further processing being applied to the content.

If the history information analyzed at step 304 indicates that the content is being sent for at least the second time, a function G is applied to the content at step 310. The function G is a scrambling function in the example embodiment. It is chosen such that the quality of the content after the function G has been applied is significantly reduced in the context of the intended purpose or by the nature of the content.

The history information associated with the content is then updated at step 306. The content, which has undergone the quality degradation procedure, is then received at the intended receiving node of the network at step 308.

The history information associated with the content can be stored in a number of ways, for example the history information can be stored in the same file as the content.

In this implementation metadata, which keeps track of how many times the content has been transferred, is associated with the content. The metadata can be considered as part of the file and be transferred and updated along with the content itself.

In another embodiment, history information about transferred files is collected and stored by the network. For example a node such as a network router can maintain a counter and use it to keep track of how many times a particular file has been routed through it based on the stored history information related to the particular file. In this embodiment any particular network node will (in most instances) only collect a partial history of a file, e.g., each router keeps track of how many times the file has been routed but not how many times other routers have routed the file. Although this is not optimal in terms of tracking a file's history it may be considered advantageous from a security point of view. In this regard the history information that is collected and kept by a router (or other node operated by the network) can be trusted since it may be assumed that the network nodes that implement function G are trusted. In contrast to this, history information stored with the content files will typically not be trusted since the file itself is subject to modification by the un-trusted peer nodes.

In accordance with a further embodiment, there is provided a quality manipulation system for controlling transmission of content in a computer network. The system includes an interface element to permit interaction with a transmission unit of a node of the network, and an application element for applying a quality degradation procedure to content being transmitted from said node.

In accordance with another embodiment, there is provided a computer program comprising program code instructing a computer to execute a procedure to perform a method of controlling transmission of content in a computer network, the method comprising the step of applying a quality degradation procedure to content being transmitted between nodes of the network. The computer program can be implemented in a wide variety of ways, including but not limited to, an application program, a hardware driver, as part of an operating system.

It will be appreciated by the person skilled in the art that numerous modifications and/or variations may be made to the present invention as shown in the specific embodiments without departing from the spirit or scope of the invention as broadly described. The present embodiments are, therefore, to be considered in all respects to be illustrative and not restrictive.

For example, quality manipulation system embodying the present invention may be implemented with an application element embedded at a network card at a node of the network, or embedded in a program, including but not limited to an application program, a hardware driver or operating system at a node of the network.

Also, content may be subjected to a processing step as part of the quality degradation procedure based on factors disassociated from the content. Those factors can include for example a current time or other statistics of the network.

Furthermore, one or more different processing steps or functions based on different parameters may be applied to the content based on the history information associated with the content or the factors disassociated from the content.

The quality degradation procedure may take many different forms other than the ones described with reference to the example embodiments. For example, the number of hops a media file has been through before its quality is seriously degraded can be selected to suit any specific requirement.

The degree and nature of the degradation after each processing step can also be chosen depending upon any specific requirement. Similarly, the quality degradation procedure can involve one or any number of different processing steps, including an identity function processing where no degradation is required for a particular transmission under the specific circumstances.

The processing step or steps can include one or more of e.g. a blurring function, a downsizing function, a scrambling function, an identity function, a watermarking function or a jamming function. In the general case any function that can be perceived as degrading the quality of or reducing certain value associated with the content may be chosen as a suitable degradation function.

A different degradation function can be applied to a file each time it is transferred. The degradation function can be chosen depending on the context and state of the history information. It should be noted that in certain cases the same degradation function could be used repeatedly.

Furthermore, the content is not limited to a particular type of digital media. Rather, it will be appreciated that the present invention applies to any type of content that may be accessed through the network, including but not limited to images, text, audio and/or video digital media.

It will be appreciated by a person skilled in the art that the history information may be provided and associated with the content in a number of different known techniques, including e.g. tagging or watermarking techniques.

It is envisaged that embodiments of the invention can be applied advantageously in distributed networks where an administrator has control over all (or most of) the nodes in the system. Application may be found in networks or situations where it is not cost-effective, or possible, to consult a remote authorization server on the network for each local content transfer.

1. A method of controlling transmission of content in a computer network, the method comprising the step of:
applying a quality degradation procedure to content being transmitted between nodes of the network.

2. The method as claimed in claim 1, wherein the quality degradation procedure comprises subjecting the content to a processing step each time the content is transmitted from one of the nodes of the network.

3. The method as claimed in claim 1, wherein the quality degradation procedure comprises determining history information associated with the content, subjecting the content to a processing step based on the history information, and updating the history information.

4. The method as claimed in claim 3, wherein the content is subjected to one or more of a group of different processing steps based on the history information.

5. The method as claimed in claim 1, wherein the quality degradation procedure comprises subjecting the content to a processing step based on factors disassociated from the content.

6. The method as claimed in claim 5, wherein the content is subjected to one or more of a group of different processing steps based on the factors disassociated from the content.

7. The method as claimed in claim 1, wherein the quality degradation procedure comprises applying one or more of a group comprising a blurring function, a downsizing function, a random noise function, a scrambling function, an identity function, a watermarking function and a jamming function to the content.

8. A quality manipulation system for controlling transmission of content in a network, the system comprising:
an interface element to permit interaction with a transmission unit of a node of the network, and
an application element for applying a quality degradation procedure to content being transmitted from said node.

9. The system as claimed in claim 8, wherein the application element subjects content to a processing step when it is transmitted from the node.

10. The system as claimed in claim 8, the application element determining history information associated with the content, subjecting the content to a processing step based on the history information, and updating the history information.

11. The system as claimed in claim 10, the application element subjecting the content to one or more of a group of different processing steps based on the history information.

12. The system as claimed in claim 8, the application element subjecting the content to a processing step based on factors disassociated from the content.

13. The system as claimed in claim 12, the application element subjecting the content to one or more of a group of different processing steps based on the factors disassociated from the content.

14. The system as claimed in claim 8, the application element applying one or more of a group comprising a blurring function, a downsizing function, a random noise function, a scrambling function, an identity function, a watermarking function and a jamming function to the content.

15. The system as claimed in claim 8, wherein the application element is embedded at a router of the network, a network card at the node, or a program at a node of the network.

16. A computer program comprising program code instructing a computer to execute a procedure to perform a method of controlling transmission of content in a network, the method comprising the step of:
applying a quality degradation procedure to content being transmitted between nodes of the network.

17. The computer program as claimed in claim 16, wherein the quality degradation procedure comprises subjecting the content to a processing step each time it is transmitted from one of the nodes of the network.

18. The computer program as claimed in claim 16, wherein the quality degradation procedure comprises determining history information associated with the content, subjecting the content to a processing step based on the history information, and updating the history information.

19. The computer program as claimed in claim 18, wherein the content is subjected to one or more of a group of different processing steps based on the history information.

20. The computer program as claimed in claim 16, wherein the quality degradation procedure comprises subjecting the content to a processing step based on factors disassociated from the content.

21. The computer program as claimed in claim 18, wherein the content is subjected to one or more of a group of different processing steps based on the factors disassociated from the content.

22. The computer program as claimed in claim 16, wherein the quality degradation procedure comprises applying one or more of a group comprising a blurring function, a downsizing function, a random noise function, a scrambling function, an identity function, a watermarking function and a jamming function to the content.

23. A node of a computer network, including an interface element configured to transmit content over a communications path to a receiving node of the network and an application element configured to apply a quality degradation procedure to the content prior to transmission.

24. The node of claim 23 wherein the node further includes at least one routing element configured to determine at least part of the route over which the content is transmitted to the receiving node of the network.

25. The node of claim 23 wherein the quality degradation procedure performed by the application element includes applying to the content, at least one function selected from the following types of functions:
a blurring function, a downsizing function, a random noise function, a scrambling function, an identity function, a watermarking function and a jamming function.

26. The node of claim 24 wherein the quality degradation procedure performed by the application element includes applying to the content, at least one function selected from the following types of functions:
a blurring function, a downsizing function, a random noise function, a scrambling function, an identity function, a watermarking function and a jamming function.

27. The node of claim 26 wherein the node is a network router.

28. The node of claim 23, wherein the quality degradation applied by the application element includes determining history information associated with the content, subjecting the content to a processing step based on the history information, and updating the history information.

29. The node of claim 28 wherein the content is subjected to one or more of a group of different processing steps based on the history information.
